(19) United States
(12) Patent Application Publication
(10) Pub. No.: US 2016/0259324 A1
(43) Pub. Date: Sep. 8, 2016

(54) SYSTEM AND METHOD FOR GUIDING DEPOSITION OF MATERIAL TO FORM THREE DIMENSIONAL STRUCTURE

(71) Applicant: Caterpillar Inc., Peoria, IL (US)

(72) Inventors: Christopher M. Sketch, Peoria, IL (US); Joseph M. Spanier, Metamora, IL (US); Todd D. Crawford, Hanna City, IL (US); Andrew D. Meinert, Metamora, IL (US); Stephen J. Pierz, Peoria, IL (US); James L. Babin, Glasford, IL (US); John A. Sherman, Peoria, IL (US)

(73) Assignee: Caterpillar Inc., Peoria, IL (US)

(21) Appl. No.: 14/639,239

(22) Filed: Mar. 5, 2015

(51) Int. Cl. G05B 19/4099

(52) U.S. Cl. CPC G05B 19/4099; G05B 2219/49023; G05B 2219/49013

(57) ABSTRACT

A method of guiding deposition of a material to form a Three Dimensional (3D) structure is disclosed. The method includes generating a tool path based on a digital model of the 3D structure via a controller and communicating the tool path to a guiding device. The method further includes generating a guiding path on a work surface via the guiding device based on the tool path and depositing the material along the guiding path via a tool member.

### TECHNICAL FIELD

The present disclosure relates to a system and a method for guiding deposition of material to form a Three Dimensional (3D) structure based on a digital model of the 3D structure.

### BACKGROUND

In the current manufacturing field, various processes, such as additive manufacturing/3D printing technique may be used for developing Three Dimensional (3D) objects. The 3D printing technique includes multiple layers of materials which are laid down on a work surface successively to form the 3D objects. Generally, a digital model of the 3D objects may be processed by computer control systems to slice the digital model into multiple layers. The output of the computer control system may be further communicated to a 3D printing tool to deposit material corresponding to each of the layers of the digital model. However, for developing large scale 3D objects such as a building or any other infrastructure, using a 3D printing tool having a scale corresponding to the large scale of the 3D object may become cost intensive.

U.S. Pat. No. 8,821,781 discloses a method for manufacturing a three dimensional (3D) object with a rear projection (RP) surface. The method includes providing a rapid prototyping machine, such as a stereolithography machine, with input material, such as a white photopolymer resin. The method includes providing a digital prototyping file, which defines thin, separately grown layers of a digital representation of the 3D object, to a computer control system. With the computer control system, the rapid prototyping machine is operated to form a 3D object using the input material and the digital prototyping file. As a result, the 3D object includes an RP element, which behaves as an RP substrate or surface. A structural portion of the 3D model has a first thickness and an RP portion has a second thickness that is less than the first thickness such that it is translucent to provide an RP element integrally formed with an adjacent structural element.

### SUMMARY OF THE DISCLOSURE

In one aspect of the present disclosure, a method of guiding deposition of a material to form a Three Dimensional (3D) structure is provided. The method includes generating, via a controller, a tool path based on a digital model of the 3D structure and communicating the tool path to a guiding device. The method further includes generating, via the guiding device, a guiding path on a work surface based on the tool path and depositing the material, via a tool member, along the guiding path.

In another aspect of the present disclosure, a system for guiding deposition of a material to form a 3D structure is provided. The system includes a controller configured to generate a tool path based on a digital model of the 3D structure. The system further includes a guiding device configured to be in communication with the controller to receive the tool path. The guiding device is further configured to project a beam based on the tool path to generate a guiding path on a work surface.

In yet another aspect of the present disclosure, a system for guiding deposition of material to form a 3D structure is provided. The system includes a controller configured to generate a tool path based on a digital model of the 3D structure. The system further includes an autonomous machine disposed to be in communication with the controller to receive the tool path. The autonomous machine is further configured to generate a flight path and move along the flight path. The flight path is generated based on the tool path.

Other features and aspects of this disclosure will be apparent from the following description and the accompanying drawings.

### BRIEF DESCRIPTION OF THE DRAWINGS

FIG. 1 is a block diagram of a system for guiding deposition of material to form a 3D structure, according to one embodiment of the present disclosure;

FIG. 2 is a schematic representation of the system of FIG. 1 disposed on a work surface;

FIG. 3 is a block diagram of a system for guiding deposition of material to form the 3D structure, according to another embodiment of the present disclosure;

FIG. 4 is a schematic representation of the system of FIG. 3 disposed on the work surface; and

FIG. 5 is a flowchart of a method of guiding deposition of material to from the 3D structure, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

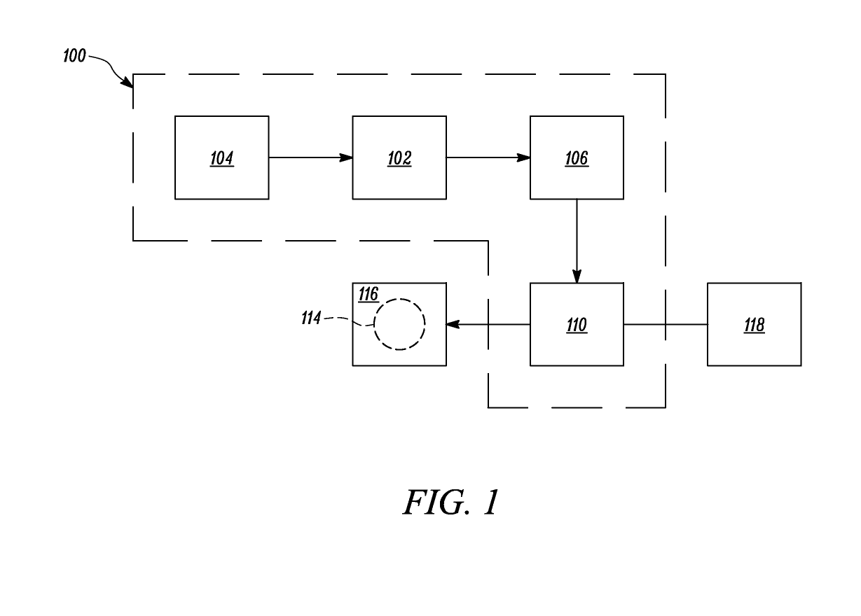

FIG. 1 is a block diagram of a system 100 for guiding deposition of a material to from a Three Dimensional (3D) structure (not shown), according to one embodiment of the present disclosure. The system 100 includes a controller 102 configured to receive a digital model 104 of the 3D structure. The digital model 104 may be a CAD model of the 3D structure that is to be developed by depositing the material. In an example, the digital model 104 may be developed by design softwares, such as, ProE, CATIA, and the like known in the art.

The controller 102 is also configured to generate a tool path 106 based on the digital model 104 of the 3D structure. In an exemplary embodiment, the controller 102 may be a software tool used for processing the digital model 104 to generate multiple tool paths. The controller 102 may cut the digital model 104 into multiple slices in various planes, preferably in a horizontal plane, to generate multiple tool paths 106 corresponding to the multiple slices. In an example, the controller 102 may be a slicing software, such as Simplify 3D, Cura or Slic3r.

The system 100 further includes a guiding device 110 configured to communicate with the controller 102 to receive the tool path 106. In the illustrated embodiment, the guiding device 110 is a projection device. The guiding device 110 is configured to project a beam 112 based on the tool path 106 to generate a guiding path 114 on a work surface 116. In an example, the guiding device 110 may be a laser projection device. However, it may be contemplated that the guiding device 110 may be any projection device known in the art.

The guiding device 110 may be further configured to generate multiple guiding paths 114 based on the multiple tool paths 106 to form the 3D structure by depositing the material along each of the multiple guiding paths 114 successively. The guiding device 110 is further configured to be disposed at a position ‘P’ relative to the work surface 116 based on a scale of the 3D structure 118. The scale of the 3D structure 118 is determined based on the digital model 104 thereof.

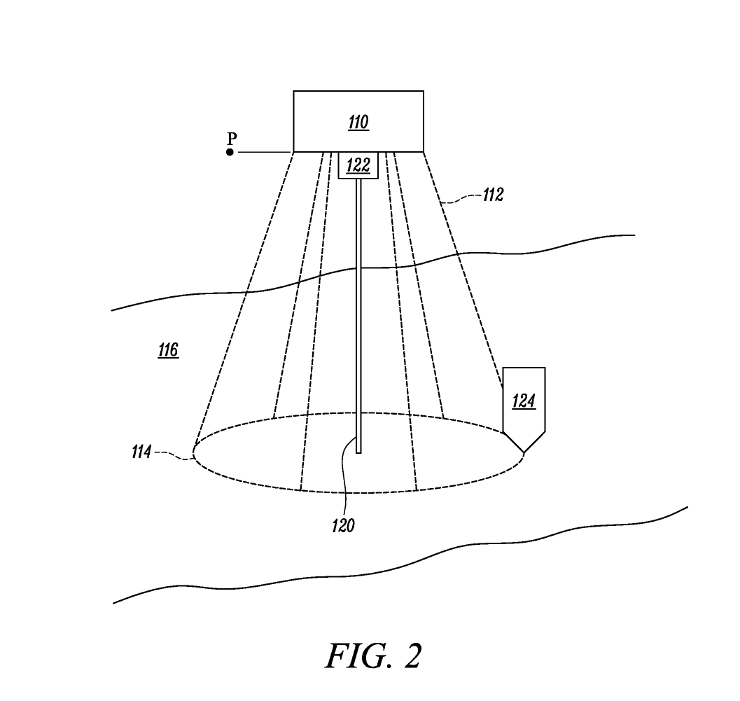

FIG. 2 is a schematic representation of the system 100 disposed on the work surface 116. The system 100 further includes a mounting member 120 disposed on the work surface 116. The mounting member 120 is configured to moveably support the guiding device 110 over the work surface 116. In various examples, the mounting member 120 may be a pole, a rod, a pipe or any other elongate body known in the art. As shown in FIG. 2, the mounting member 120 is disposed vertically with respect to the work surface 116 to support the guiding device 110. It may be contemplated that the mounting member 120 may be disposed at any position relative to the work surface 116 depending on the scale of the 3D structure 118.

The guiding device 110 is supported on the mounting member 120 at the position ‘P’ based on the scale of the 3D structure 118. Specifically, the position ‘P’ of the guiding device 110 on the mounting member 120 may be determined based on a height of the 3D structure that is to be formed on the work surface 116. It may be contemplated that the guiding device 110 may be moved to various positions along the mounting member 120 according to the guiding path 114 that is to be defined based on the scale of the 3D structure 118. Further, the position ‘P’ of the guiding device 110 over the work surface 116 may also be determined based on an area of the work surface 116 on which the 3D structure is to be formed.

The system 100 further includes a motor 122 disposed on the mounting member 120. In an example, the motor 122 may be an electric motor. The motor 122 is configured to rotatably dispose the guiding device 110 on the mounting member 120. The motor 122 may facilitate a movement of the guiding device 110 to various angular positions. The motor 122 may further facilitate a 360 degree rotation of the guiding device 110 relative to the mounting member 120. In an embodiment, the motor 122 may receive power from an electric power source (not shown), such as a battery associated with the guiding device 110. In other embodiments, the motor 122 may receive power from external power sources located remotely to the work surface 116. Thus the guiding device 110 may generate the guiding path 114 based on the position ‘P’ with respect to the work surface 116.

In an embodiment, the guiding device 110 may be configured to project a plurality of beams 112 to define the guiding path 114 on the work surface 116. The plurality of beams 112 may correspond to the tool path 106 specific to one layer of the digital model 104 defined by the controller 102. As such, the plurality of beams 112 may be generated for the tool path 106 corresponding to each of the layers of the digital model 104 to form the 3D structure on the work surface 116.

In another embodiment, the guiding device 110 is configured to project a single beam 112 to define the guiding path 114 on the work surface 116. In such a case, the guiding device 110 may be moved via the motor 122 to define the guiding path 114 on the work surface 116. Further, the motor 122 may be configured to move the guiding device 110 based on the tool path 106.

The system 100 further includes a tool member 124 configured to deposit the material on the work surface 116 along the guiding path 114. In the illustrated embodiment, the tool member 124 is operated by an operator to deposit the material along the guiding path 114. In an example, the tool member 124 may be an extruder and the material may be ceramic, dirt, clay, plastic, metal or a combination thereof. The operator may follow the guiding path 114 along with the tool member 124 to deposit the material. In various embodiments, the operator may use one or more tool holding devices (not shown), such as a pneumatic manipulator arm to move the tool member 124 along the guiding path 114. Further, the operator may use a lift, such as a scissor lift to deposit the material along the guiding path 114 depending on the scale of the 3D structure 118. A method of depositing the material may be determined based on the scale and precision of the 3D structure. In an example, the method of depositing the material may be selected from one of a fused filament deposition, a cold extrusion, a laser engineered net shaping and other methods known in the art.

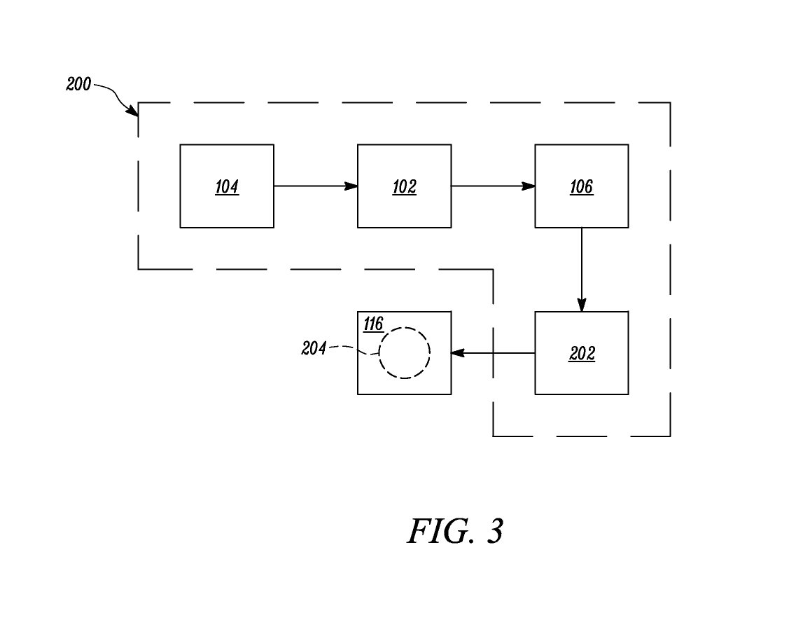

FIG. 3 is a block diagram of a system 200 for guiding deposition of the material to from the 3D structure, according to another embodiment of the present disclosure. As described above with reference to FIG. 1, the system 200 includes the controller 102 to receive the digital model 104 of the 3D structure. The controller 102 is further configured to generate the tool path 106 based on the digital model 104 of the 3D structure.

The system 200 further includes an autonomous machine 202 disposed in communication with the controller 102 to receive the tool path 106. The autonomous machine 202 is configured to generate a flight path 204 based on the tool path 106. Further, the autonomous machine 202 is configured to move along the flight path 204. In an exemplary embodiment, the autonomous machine 202 may include one or more control modules (not shown) configure to communicate with the controller 102 to receive the tool path 106. The control modules may further generate the flight path 204 based on the tool path 106 such that the autonomous machine 202 moves along the flight path 204. The flight path 204 is further determined based on the scale of the 3D structure 118.

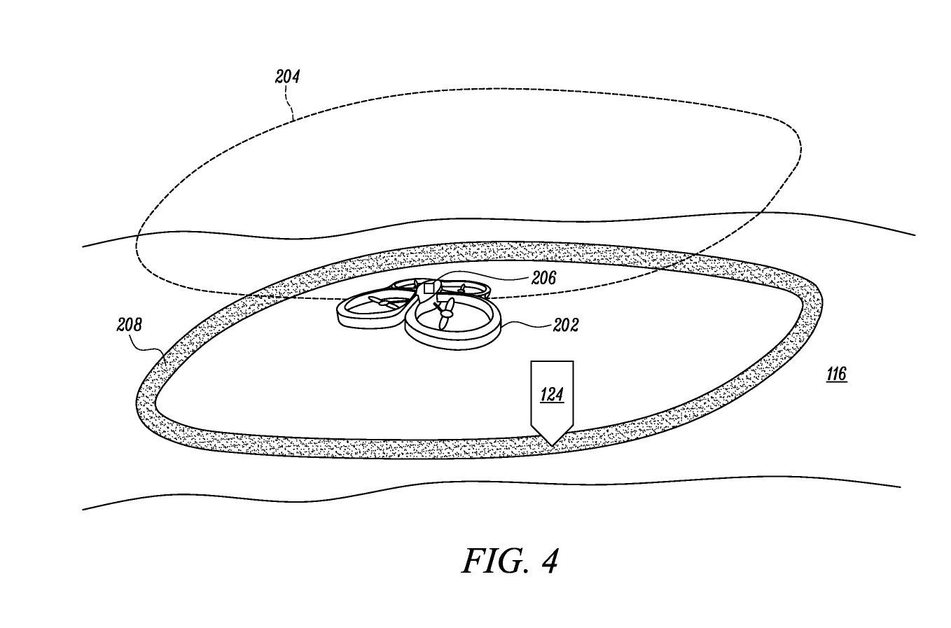

FIG. 4 is a schematic representation of the system 200 disposed on the work surface 116 to form the 3D structure. The system 200 further includes a positioning system 206 configured to track a location of the autonomous machine 202 with respect to the work surface 116. The positioning system 206 may also be configured to track a movement of the autonomous machine 202 along the flight path 204 over the work surface 116. In an example, the positioning system 206 may be a satellite navigation system, such as a GPS. However, it may be contemplated that the positioning system 206 may be any other positioning systems known in the art for tracking movement of the autonomous machine 202 over the work surface 116.

The system 200 further includes the tool member 124 configured to deposit the material on the work surface 116 along the flight path 204. In FIG. 4, the material 208 deposited on the work surface 116 is shown. The tool member 124 may be operated by the operator to deposit the material along the flight path 204. In the illustrated embodiment, the operator may follow the flight path 204 along with the tool member 124 to deposit the material. In various embodiments, the operator may move the tool member 124 along the flight path 204 via the tool holding device as describe above.

### INDUSTRIAL APPLICABILITY

The present disclosure relates to the systems 100, 200 and a method 500 of guiding deposition of the material to form the 3D structure. The systems 100, 200 may be configured to define the 3D structures, such as buildings or other infrastructures, which are substantially large in scale. Further, the guiding path 114 and the flight path 204 generated by the systems 100, 200, respectively, on the work surface 116 may be used for depositing the material on the work surface 116. The operator may follow the guiding path 114 or the flight path 204 to deposit the material. Thus, the large scale 3D structure may be formed on the work surface 116 at lesser cost with use of the systems 100, 200 and/or the method 500 compared to using large scale 3D printing tools for making such large scale structures.

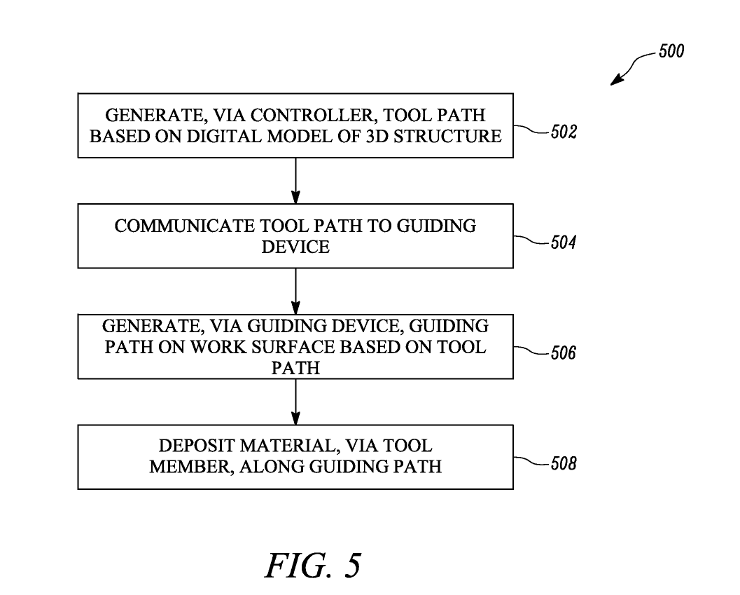

FIG. 5 is a flowchart of the method 500 of guiding deposition of material to from the 3D structure, according to an embodiment of the present disclosure. The method 500 may be described in detail with reference to various steps. At step 502, the method 500 includes generating the tool path 106 based on the digital model 104 of the 3D structure. The digital model 104 of the 3D structure is provided as an input to the controller 102. The digital model 104 may be further sliced into multiple layers in one or more planes. Further, the controller 102 may generate the tool path 106 corresponding to each of the layers of the digital model 104. The number of tool paths 106 corresponding to the number of layers of the digital model 104 may vary depending on a complexity of the digital model and also the method of depositing the material.

At step 504, the method 500 includes communicating the tool path 106 to the guiding device 110. In an embodiment, the controller 102 may be included in the guiding device 110 such that the guiding device 110 may directly receive the tool path 106 from the controller 102. In another embodiment, the controller 102 may be separate from the work surface 116. In such a case, the guiding device 110 may communicate with the controller 102 via one of a wireless communication and a wired communication depending on a location of the controller 102 with respect to the guiding device 110. In yet another embodiment, the guiding device 110 may be the autonomous machine 202. In such a case, the control modules of the autonomous machine 202 may communicate with the controller 102 to receive the tool path 106. In one example, the controller 102 may be included within the autonomous machine 202. In another example, the controller 102 may be separate from the autonomous machine 202.

The method 500 further includes determining the scale of the 3D structure 118 based on the digital model 104. Further, the position of the guiding device 110 with respect to the work surface 116 is determined based on the scale of the 3D structure 118. The guiding device 110 is further supported on the mounting member 120 based on the position thereof with respect to the work surface 116. Thus the guiding path 114 is determined based on the scale of the 3D structures 118 and the position of the guiding device 110 on the mounting member 120. The motor 122 may movably support the guiding device 110 on the mounting member 120.

At step 506, the method 500 includes generating the guiding path 114 on the work surface 116 based on the tool path 106 via the guiding device 110. In an embodiment, the guiding device 110 projects the plurality of beams 112 on the work surface 116 based on the tool path 106 corresponding to each of the layers of the digital model 104. In another embodiment, the guiding device 110 projects the single beam 112 based on the tool path 106. Further, the guiding device 110 may be moved via the motor 122 to define the guiding path 114 on the work surface 116.

In another embodiment, the method 500 includes generating the flight path 204 based on the tool path 106. The tool path 106 is communicated with the autonomous machine 202 such that the control modules of the autonomous machine 202 may generate the flight path 204. The flight path 204 may be generated further based on the scale of the 3D structure 118. The autonomous machine 202 is further operated to move along the flight path 204. The positioning system 206 may track a location and a movement of the autonomous machine 202 relative to the work surface 116. Thus, an operator may control the position and the movement of the autonomous machine 202 over the work surface 116 based on input received from the positioning system 206.

At step 508, the method 500 includes depositing the material along the guiding path 114 via the tool member 124 in one embodiment. The operator may follow the guiding path 114 along with the tool member 124 to deposit the material along the guiding path 114. In such a case, the operator may control amount of the material deposited on the work surface 116 along the guiding path 114. The operator may also use tool holding devices to handle the tool member 124 and to follow along the guiding path 114. The operator may continue to deposit the material via the tool member 124 until the 3D structure is formed on the work surface 116. In another embodiment, the operator may follow the flight path 204 of the autonomous machine 202 to deposit the material on the work surface 116 to form the 3D structure.

With use/implementation of the present systems 100, 200 and the method 500, any large scale 3D structure such as a building or any infrastructure may be formed on the work surface 116 at a lesser cost compared to the existing systems and methods of forming a large scale 3D structure. Further, by enabling an operator to handle the tool member 124, a complexity in depositing the material on the work surface 116 may be reduced. Also, the operator may use cost effective tool holding devices and/or the lifts to follow the guiding path 114 or the flight path 204 for depositing the material. Thereby, method of depositing the material on the work surface 116 may be simplified.

Further, the operator with less operational skills also can follow the guiding path 114 or the flight path 204 to deposit the material. As the guiding device 110 and the autonomous machine 202 are portable, the 3D structure may be formed at any location on the work surface 116 without incurring substantial transportation costs. Further, the guiding device 110 may also be mounted on a tree or a tall building adjacent to the work surface 116 where the 3D structure needs to be formed, such that a cost of procuring the mounting member 120 and installation thereof on the work surface 116 may be avoided.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of guiding deposition of a material to form a Three Dimensional (3D) structure, the method comprising:
generating, via a controller, a tool path based on a digital model of the 3D structure;
communicating the tool path to a guiding device;
generating, via the guiding device, a guiding path on a work surface based on the tool path; and
depositing the material, via a tool member, along the guiding path.

2. The method of claim 1 further comprising:
determining a scale of the 3D structure based on the digital model thereof; and
determining the guiding path based on the scale of the 3D structure.

3. The method of claim 2 further comprising determining a position of the guiding device with respect to the work surface based on the scale of the 3D structure.

4. The method of claim 3 further comprising supporting the guiding device on a mounting member based on the position of the guiding device with respect to the work surface.

5. The method of claim 1 further comprising projecting a plurality of beams based on the tool path to define the guiding path on the work surface.

6. The method of claim 1 further comprising projecting a single beam based on the tool path to define the guiding path on the work surface.

7. The method of claim 1, wherein generating the guiding path comprises:
generating a flight path based on the tool path; and
moving an autonomous machine along the generated flight path.

8. The method of claim 7 further comprising tracking, via a positioning system, a location of the autonomous machine with respect to the work surface.

9. A system for guiding deposition of a material to form a 3D structure, the system comprising:
a controller configured to generate a tool path based on a digital model of the 3D structure; and
a guiding device configured to be in communication with the controller to receive the tool path, the guiding device further configured to project a beam based on the tool path to generate a guiding path on a work surface.

10. The system of claim 9 further comprising a mounting member disposed on the work surface, the mounting member configured to moveably support the guiding device over the work surface.

11. The system of claim 10, wherein the guiding device is supported on the mounting member at a position based on a scale of the 3D structure relative to the digital model thereof.

12. The system of claim 10 further comprising a motor disposed on the mounting member, the motor configured to rotatably dispose the guiding device on the mounting member.

13. The system of claim 11, wherein the guiding device is further configured to generate the guiding path based on the position thereof with respect the work surface.

14. The system of claim 9, wherein the guiding device is configured to project a plurality of beams to define the guiding path on the work surface.

15. The system of claim 9, wherein the guiding device is configured to project a single beam to define the guiding path on the work surface.

16. The system of claim 9 further comprising a tool member configured to deposit the material on the work surface along the guiding path.

17. A system for guiding deposition of material to form a 3D structure, the system comprising:
a controller configured to generate a tool path based on a digital model of the 3D structure; and
an autonomous machine disposed to be in communication with the controller to receive the tool path, the autonomous machine further configured to generate a flight path and move along the flight path, wherein the flight path is generated based on the tool path.

18. The system of claim 17 further comprising a positioning system configured to track a location of the autonomous machine with respect to the work surface.

19. The system of claim 17, wherein the flight path is determined based on a scale of the 3D structure relative to the digital model thereof.

20. The system of claim 17 further comprising a tool member configured to deposit the material on the work surface along the flight path.
